(19) United States
(12) Patent Application Publication
(10) Pub. No.: US 2019/0371072 A1
(43) Pub. Date: Dec. 5, 2019

(54) STATIC OCCLUDER

(71) Applicant: Apple Inc., Cupertino, CA (US)

(72) Inventors: Adrian P. Lindberg, San Jose, CA (US); Amritpal Singh Saini, Toronto (CA); Stefan Auer, Sunnyvale, CA (US)

(21) Appl. No.: 16/427,574

(22) Filed: May 31, 2019

Related U.S. Application Data
(60) Provisional application No. 62/679,160, filed on Jun. 1, 2018.

(51) Int. Cl. G06T 19/00; G06K 9/00; G06F 3/01; G02B 27/01

(52) U.S. Cl. CPC G06T 19/006; G02B 27/017; G06F 3/011; G06K 9/00214

(57) ABSTRACT

Some implementations involve, on a computing device having a processor, a memory, and an image sensor, obtaining an image of a physical environment using the image sensor. Various implementations detect a depiction of a physical environment object in the image, and determine a 3D location of the object in a 3D space based on the depiction of the object in the image and a 3D model of the physical environment object. Various implementations determine an occlusion based on the 3D location of the object and a 3D location of a virtual object in the 3D space. A CGR experience is then displayed based on the occlusion, where at least a portion of the object or the virtual object is occluded by the other.

### CROSS-REFERENCE TO RELATED APPLICATION

This Application claims the benefit of U.S. Provisional Application Ser. No. 62/679,160 filed Jun. 1, 2018, which is incorporated herein in its entirety.

### TECHNICAL FIELD

The present disclosure generally relates to a computer-generated reality (CGR) experience, and in particular, to systems, methods, and devices for providing occlusion in the CGR experience.

### BACKGROUND

A CGR environment refers to a wholly or partially simulated environment that people sense and/or interact with via an electronic system. The CGR experience is typically experienced by a user using a mobile device, head-mounted device (HMD), or other device that presents the visual or audio features of the environment. The CGR experience can be, but need not be, immersive, e.g., providing most or all of the visual or audio content experienced by the user. The CGR experience can be video-see-through (e.g., in which the physical environment is captured by a camera and displayed on a display with additional content) or optical-see-through (e.g., in which the physical environment is viewed directly or through glass and supplemented with displayed additional content). For example, a CGR system may provide a user with the CGR experience using video see-through on a display of a consumer cell-phone by integrating rendered three-dimensional (“3D”) graphics (e.g., virtual objects) into a live video stream captured by an onboard camera. As another example, a CGR system may provide a user with the CGR experience using optical see-through by superimposing rendered 3D graphics into a wearable see-through head mounted display (“HMD”), electronically enhancing the user's optical view of the physical environment with the superimposed virtual objects. Existing computing systems and applications do not adequately provide occlusion of the physical environment (e.g., real objects) and virtual objects depicted in a CGR experience with respect to one another.

### SUMMARY

Various implementations disclosed herein include devices, systems, and methods that perform occlusion handling for a CGR experience. An image or sequence of images is captured, for example by a camera, and combined with a virtual object to provide a CGR environment. Occlusion between a real object and the virtual object in the CGR environment occurs where, from the user's perspective, the real object is in front of the virtual object and thus obscures all or a portion of the virtual object from view, or vice versa. In order to accurately display such occlusions, implementations disclosed herein determine relative positions and geometries of the real object and virtual object in a 3D space. The position and geometry of the real object, e.g., a sculpture in a museum, is determined using the image data to identify the object's position and combined with a stored 3D model of the real object, e.g., a 3D model corresponding to the sculpture. Using a 3D model of the real object provides accurate geometric information about the real object that may be otherwise unavailable from inspection of the image alone. Accurate occlusions are determined using the accurate relative positions and geometries of the real object and virtual object in the 3D space. Accordingly, the real object will be occluded by the virtual object when the virtual object is in front of it and vice versa. In some implementations, the occlusion boundaries (e.g., at the regions of a view of the CGR environment at which an edge of the virtual object is adjacent to an edge of the real object) are corrected to further improve the accuracy of a displayed occlusion.

Some implementations of the disclosure involve, on a computing device having a processor, a memory, and an image sensor, obtaining an image of a physical environment using the image sensor. These implementations next detect a depiction of a real object in the image, e.g., in a current frame, and determine a three dimensional (3D) location of the object in a 3D space based on the depiction of the real object in the image and a 3D model of the real object. Various implementations determine an occlusion based on the 3D location of the real object and a 3D location of a virtual object in the 3D space. The CGR environment is then provided for viewing on a display based on the occlusion. The CGR environment includes the real object and the virtual object, where at least a portion of the real object or the virtual object is occluded according to the determined occlusion. In some implementations, the image sensor captures a sequence of frames and the occlusion is added for each frame in the sequence of frames. Thus, accurate occlusion between the virtual object and the real object is determined and displayed in real time during the CGR experience. In some implementations, such occlusions change over time, for example, based on movement of the real object, movement of the virtual object, movement of the image sensor or combinations thereof.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, an image sensor, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example environment.

FIG. 2 is a block diagram of a mobile device capturing a frame of a sequence of frames in the environment of FIG. 1 in accordance with some implementations.

FIG. 3 is a block diagram showing a 3D model of a real object exists that is accessible to the mobile device of FIG. 2 in accordance with some implementations.

FIG. 4 is a block diagram of the mobile device of FIG. 2 presenting a CGR experience that includes a virtual real object in accordance with some implementations.

FIGS. 5A-5C are block diagrams of the mobile device of FIG. 2, using a sequence of frames, to present a CGR environment that includes a real object and a virtual object in accordance with some implementations.

FIG. 6 is a block diagram of the mobile device of FIG. 2 presenting a CGR environment that includes a real object and a virtual object in accordance with some implementations.

FIG. 7 is a block diagram illustrating an occlusion uncertainty area is resolved for precise or consistent CGR experiences in an occlusion boundary region in accordance with some implementations.

FIG. 8 is a block diagram illustrating device components of an exemplary device according to some implementations.

FIG. 9 is a flowchart representation of a method for occlusion rendering in a CGR experience according to some implementations.

FIG. 10 is a flowchart representation of a method for occlusion boundary rendering in a CGR experience according to some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects or variants do not include all of the specific details described herein. Moreover, well-systems, methods, components, devices and circuits have not been described in exhaustive detail so as not to obscure more pertinent aspects of the example implementations described herein.

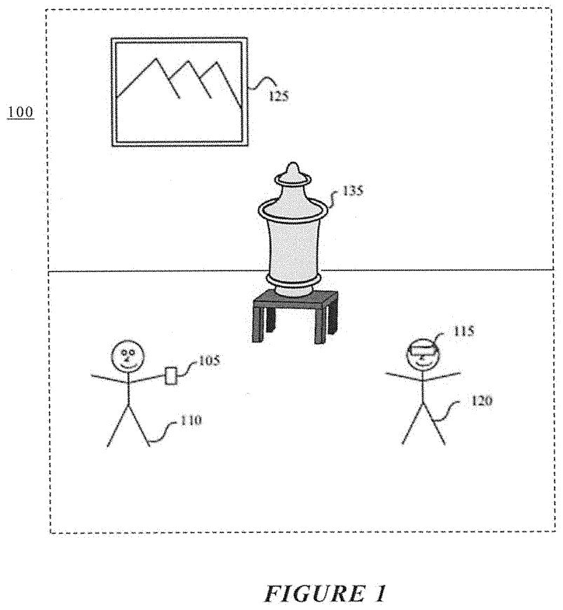

Referring to FIG. 1, an example environment 100 for implementing aspects of the present disclosure is illustrated. In general, operating environment 100 represents two devices 105, 115 amongst a physical environment including real objects. As depicted in the example of FIG. 1, the environment 100 includes a first device 105 being used by a first user 110 and a second device 115 being used by a second user 120. In this example, the environment 100 is a museum that includes picture 125 and sculpture 135. The two devices 105, 115 can operate alone or interact with additional devices not shown to capture images of the physical environment, detect or track objects in those images, or to present a CGR environment based on the images and the detected/tracked objects. Each of the two device 105, 115 may communicate wirelessly or via a wired connection with a separate controller (not shown) to perform one or more of the these functions. Similarly, each of the two device 105, 115 may store reference images and other object-specific information useful for these functions or may communicate with a separate device such as a server or other computing device that stores this information. For example, the museum may have compiled a collection of reference images of the real objects, 3D models of the real objects, and descriptive information of the real objects that are stored on or accessible to the two devices 105, 115. These 3D models of the real objects may be used by devices 105 and 115 to perform occlusion in the CGR environment after detecting the physical environment objects in images captured by the devices.

In some implementations, a device, such as device 115, is a head-mounted device (HMD) that worn by a user. An HMD may enclose the field-of-view of the second user 120. The HMD can include one or more screens or other displays configured to display a CGR environment. In some implementations, an HMD includes a screen or other display to display the CGR environment in a field-of-view of the second user 120. In some implementations, the HMD is worn in a way that a screen is positioned to display the CGR environment in a field-of-view of the second user 120.

In some implementations, a device, such as the first device 105 is a handheld electronic device (e.g., a smartphone or a tablet) configured to present the CGR environment to the first user 110. In some implementations, the first device 105 is a chamber, enclosure, or room configured to present a CGR environment in which the first user 110 does not wear or hold the first device 105.

A CGR environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands).

A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects.

Examples of CGR include virtual reality and mixed reality. A virtual reality (VR) environment refers to a simulated environment that is designed to be based entirely on computer-generated sensory inputs for one or more senses. A VR environment comprises virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end.

In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground.

Examples of mixed realities include augmented reality and augmented virtuality. An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment.

An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

An augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

There are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

In some implementations, the first device 105 and second device 115 enable the user to change the viewpoint or otherwise modify or interact with the CGR environment. In some implementations, the first device 105 and second device 115 are configured to receive user input that interacts with displayed content. For example, a virtual object such as a 3D representation of a person or object in the physical environment, or informational displays each with interactive commands may be presented in the CGR environment. A user may reposition the virtual object or informational displays relative to the depicted real objects or interact with the interactive commands by providing user input on or otherwise using the respective device. In one example, a user verbally states “move the ball”, “change the background” or “tell me more about the sculpture” to initiate or change the display of virtual object content or the CGR environment.

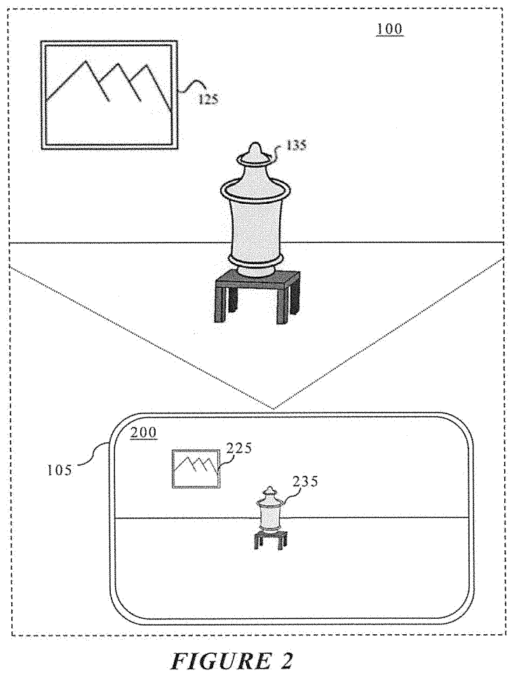

FIG. 2 is a block diagram of the first device 105 capturing an image 200 in the environment 100 of FIG. 1 in accordance with some implementations. In this example, the first user 110 has positioned the first device 105 in the environment 100 such that an image sensor of the first device 105 captures an image 200 of the picture 125 and the sculpture 135. The captured image 200 may be a frame of a sequence of frames captured by the first device 105, for example, when the first device 105 is executing a CGR environment application. In the present example, the first device 105 captures and displays image 200, including a depiction 225 of the picture 125 and a depiction 235 of the sculpture 135.

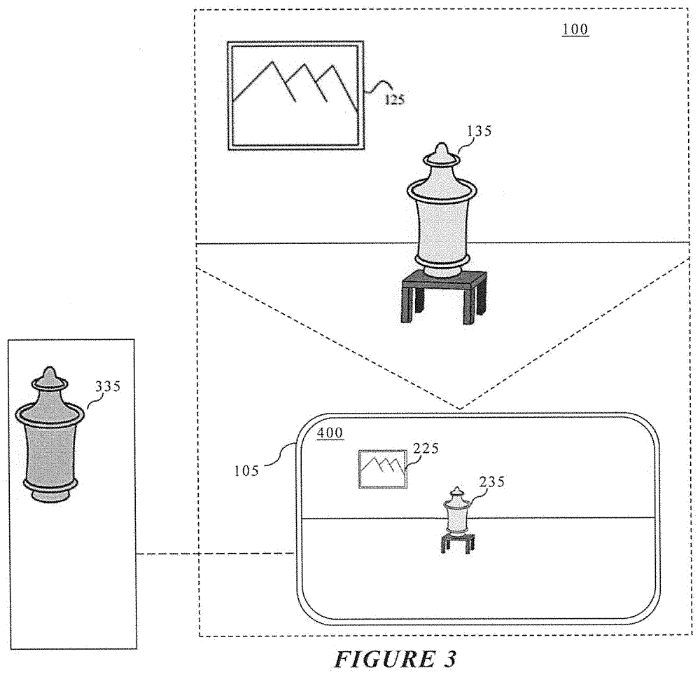

FIG. 3 is a block diagram depicting that a 3D representation of a real object exists and is accessible to the first device 105 capturing the image 200. As shown in FIG. 3, a 3D representation 335 of the real object sculpture 135 is accessible to the first device 105. In some implementations, the 3D representation 335 is stored on the first device 105 or remotely. In contrast, there is no 3D representation of the picture 125. The 3D representation 335 represents a 3D surface model or a 3D volume model of the sculpture 135. In one implementation, the 3D representation 335 is very precise, highly detailed 3D representation 335 and can include information that is not readily apparent or easily/quickly/accurately determinable based on inspection of the image, e.g., from the depiction 235.

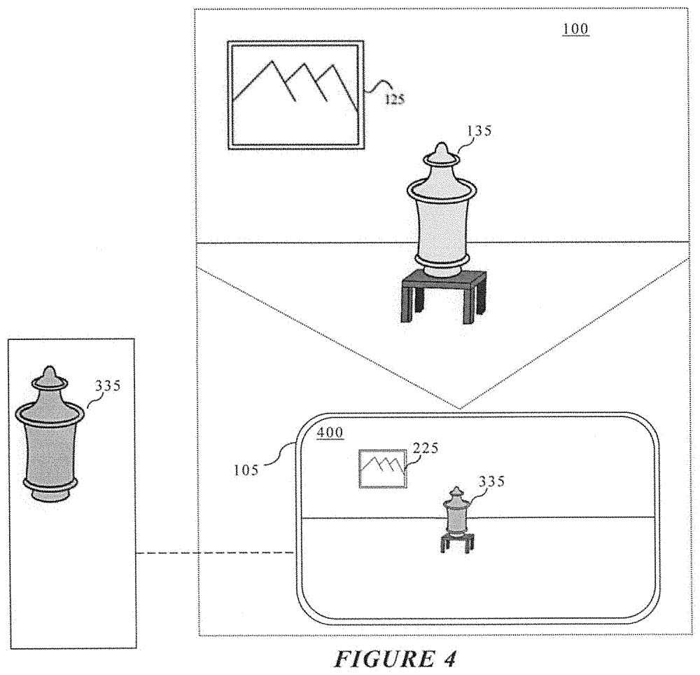

FIG. 4 is a block diagram of the first device 105 of FIG. 2 presenting a captured image 400 that includes the depiction 225 of the picture 125 and the 3D representation 335 (e.g., additional content) that is positioned based on a pose of the sculpture 135 detected in the captured image 400 of the environment 100. In some implementations, the captured image 400 can be a CGR environment.

In various implementations, the first device 105 may detect an object and determine its pose (e.g., position and orientation in 3D space) based on conventional 2D or 3D object detection and localization algorithms, visual inertial odometry (VIO) information, infrared data, depth detection data, RGB-D data, other information, or some combination thereof as shown in FIG. 4. In some implementations, the pose is detected in each frame of the captured image 400. In one implementation, after pose detection in a first frame, in subsequent frames of the sequence of frames, the first device 105 can determine an appropriate transform (e.g., adjustment of the pose) to determine the pose of the object in each subsequent frame. As shown in FIG. 4, the first device 105 detects the sculpture 135 in the captured image 400 and replaces or supplements the depiction 235 of the sculpture 135 in the captured image 400 with the additional content or the 3D representation 335.

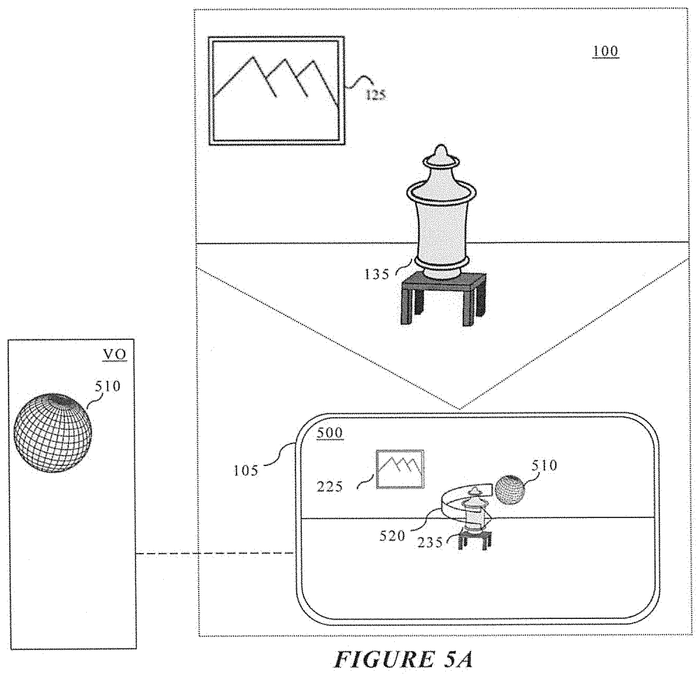

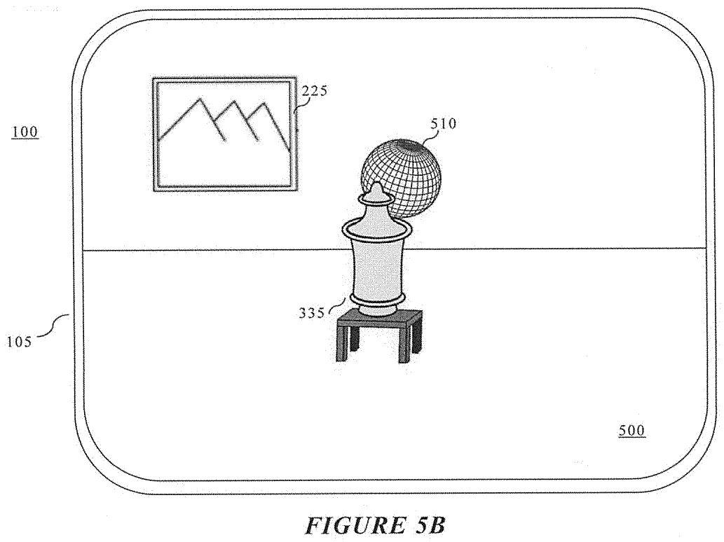

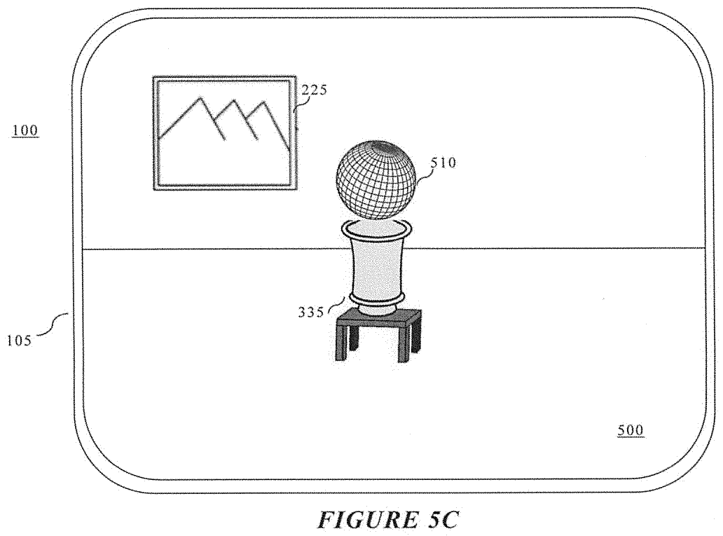

As will be illustrated in FIGS. 5A-5C, depictions of virtual objects (virtual object) can be combined with real objects of the physical environment from the images captured of the environment 100. In various implementations, using accessible virtual object 510 and selectable operator actions, the virtual object 510 can be added to CGR environment 500.

FIG. 5A is a block diagram of the first device 105 of FIG. 2 presenting CGR environment 500 that includes the depiction 225 of the picture 125 and the depiction 235 of the detected sculpture 135, where the depiction 235 realistically interacts (e.g., handles occlusion) with the ball virtual object 510. As shown in FIG. 5, the first device 105 (e.g., via the user 110 interacting with the first device 105 or based on computer-implemented instructions) can controllably change the pose (e.g., position and orientation in 3D space) of the ball virtual object 510 in the CGR environment 500. In various implementations, the first device 105 tracks the pose of the ball virtual object 510 in the CGR environment 500 over time. Further, the first device 105 determines and updates the pose of the real world sculpture 135. The first device 105 additionally retrieves or accesses the 3D representation 335 to provide additional and often more accurate information about the geometry and pose of the sculpture 135. Generally, the first device 105 can depict relative positions in the CGR environment 500 for the ball virtual object 510, the depicted sculpture 235 relative to each other or relative to the point of view of the image sensor of the first device 105. The determined poses and geometric information about the sculpture 135 and virtual object ball 510 are used to display the CGR environment 500. The information can be used to determine accurate occlusions and 3D interactions between the sculpture 135 in the physical environment and the virtual object ball 510 that should be depicted in the CGR environment 500.

In this example of FIGS. 5A-5C, the ball virtual object 510 appears to travel an exemplary path 520 (e.g., by showing realistic occlusion between the depicted sculpture 235 and the ball virtual object 510 in the CGR environment 500). The realistic occlusion is enabled by the accurate and efficient determination of the 3D reconstruction 335 and the pose of the sculpture 135, and the location of the ball virtual object 510 in the CGR environment 500. In FIG. 5A, there is no occlusion between the ball virtual object 510 and the depicted sculpture 235 in the CGR environment 500. In FIG. 5B, the ball virtual object 510 is behind and occluded by the depicted sculpture 235 in the CGR environment 500. In FIG. 5C, the ball virtual object 510 is in front of and occludes the depicted sculpture 235 in the CGR environment 500. Thus, the ball virtual object 510 realistically travels the path 520 around the depiction of the sculpture 225 in accordance with some implementations.

In various implementations, the first user 110 may be executing a CGR environment application on the first device 105. In some implementations, the first user 110 can physically move around the environment 100 to change the depiction in the CGR environment 500. As the first user 110 physically moves around the environment 100, an image sensor on the first device 105 captures a sequence of frames, e.g., captured images of the environment 100 from different positions and orientations (e.g., camera poses) within the environment 100. In some implementations, even though the ball virtual object 510 is fixed relative to the sculpture 135, physical motion by the image sensor can change the occlusion relationship, which is determined by the first device 105 and presented correctly in the CGR environment 500. In some implementations, both the image sensor on the first device 105 and the ball virtual object 510 can move and the occlusion relationship is determined by the first device 105 and presented correctly in the CGR environment 500.

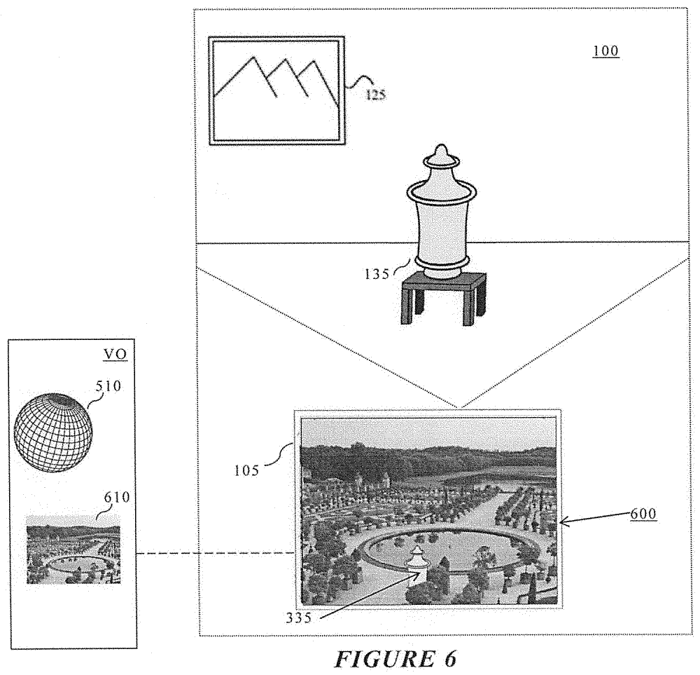

As will be illustrated in FIG. 6, virtual objects can include virtual scenes in which physical environments are depicted. Such virtual scenes can include some or all of a physical environment (e.g., environment 100). In various implementations, using accessible virtual object 610 and selectable operator actions, the virtual object 610 can be added to CGR environment 600. As shown in FIG. 6, the environment virtual object 610 (e.g., grounds of the Palace of Versailles) can include part or all of the CGR environment 600. In some implementations, the depiction of the sculpture 235 is shown in a virtual object environment such that poses of objects in the virtual object 610 are known and can correctly depict occlusion, for example, caused by relative motion of the user 110 through the virtual object 610 relative to the pose of the sculpture 135 and 3D model 335.

As shown in FIG. 6, based on the pose of the sculpture 135 and 3D model 335, the depiction of the sculpture 235 is behind a portion of the environment virtual object 610 and has a bottom portion occluded by bushes. The depiction of the sculpture 235 is in front of and has a top portion occluding a fountain of the environment virtual object 610. In various implementations, such occlusions would change, for example, as the user 110 moves through the virtual object 610 or as the sculpture 135 moves in the environment 100. In some implementations, additional virtual objects such as the ball virtual object 510 can be added to the CGR environment 600.

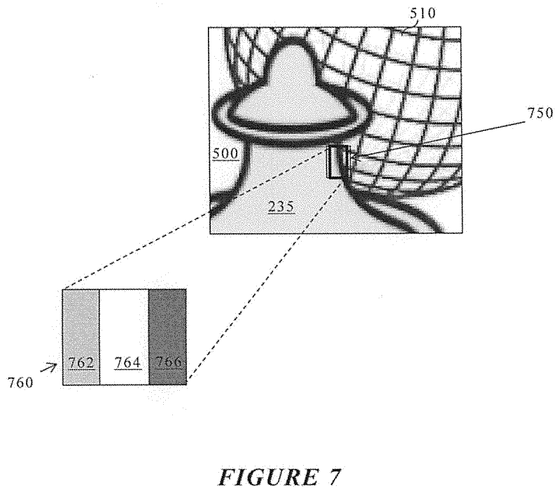

FIG. 7 is a block diagram illustrating an occlusion uncertainty area that can occur in an occlusion boundary region in a CGR environment in accordance with some implementations. In various implementations, an occlusion uncertainty area 750 can occur at an occlusion boundary between detected real objects and virtual objects in the CGR environment 500. In some implementations, the occlusion uncertainty area 750 is caused by where and how the detected real objects and the virtual objects overlap in the CGR environment 500. In some implementations, the occlusion uncertainty area 750 can be a preset or variable size or a preset or variable number of pixels (e.g., a few pixels or tens of pixels) based on the display device characteristics, size of the detected real objects and the virtual objects, motion of the detected real objects and the virtual objects or the like. In some implementations, the occlusion uncertainty area 750 is resolved before generating or displaying the CGR environment (e.g., CGR environment 500). In some implementations, the occlusion uncertainty area 750 is resolved on a frame-by-frame process. In some implementations, the occlusion uncertainty area 750 is resolved by an occlusion boundary region correction process. In some implementations, algorithms process criteria that precisely determines whether each pixel in the occlusion boundary region is to be corrected based on determining whether the pixel should be part of the virtual object or the detected real object and is occluded or visible. In some implementations, the occlusion boundary region is corrected at full image resolution. In some implementations, the occlusion boundary region is corrected at least in part using a reduced image resolution.

In some implementations, the occlusion uncertainty area 750 is caused at least in part by a mis-match between the CGR environment 3D coordinate system and the first device 105 3D coordinate system (e.g., the image sensor). For example, a pose/geometry of a real object is determined in first 3D spatial coordinates, and compared to a pose/geometry of a virtual object determined in the same first 3D spatial coordinates. Based on those positional relationships, occlusion between the real object and the virtual object is determined and realistically displayed from the image sensor/user viewpoint. The occlusion can be re-determined in each subsequent frame of a sequence of frames as the objects move relative to each other and the image sensor/user viewpoint. In some implementations, the first 3D spatial coordinates are in a first 3D coordinate system of the displayed CGR environment. In some implementations, the first 3D spatial coordinates are in the coordinate system used by a VIO system at the device 105. In contrast, the captured images of the image sensor are in a second 3D coordinate system of the device 105 (e.g., the image sensor).

As shown in FIG. 7, an occlusion boundary region 760 overlaps the occlusion uncertainty area 750. The occlusion boundary region 760 can be the same size or a different size than the occlusion uncertainty area 750. In some implementations, the occlusion boundary region 760 can be represented as a boundary condition or mask. As shown in FIG. 7, the occlusion boundary region 760 is a tri-mask where first pixels 762 are known to be in the real object depiction 235 and third pixels 766 are known to be in the virtual object depiction 510, and uncertain second pixels 764 need to be resolved before generation or display of the CGR environment 500. In some implementations, the uncertain second pixels 764 are a preset or variable number of pixels. In some implementations, the occlusion boundary region 760 is resolved within a single frame of image data (e.g., a current frame). In some implementations, the occlusion boundary region 760 is resolved using multiple frames of image data (e.g., using information from one or more previous frames). For example, movement (e.g., an amount of rotational or translational movement) relative to previous frames can be used to correct the uncertain second pixels 764 in the current frame. In some implementations, the second pixels 764 are resolved using a localized consistency conditions. In some implementations, the second pixels 764 are resolved using local chromatic consistencies or occlusion condition consistencies.

The examples of FIGS. 2-7 illustrate various implementations of occlusion handling in CGR environments for a real object having an accessible corresponding 3D virtual model. The efficient and accurate determination of occlusion using techniques disclosed herein can enable or enhance CGR experiences. For example, the first user 110 may be executing a CGR environment application on the first device 105 and walking around the environment 100. In various implementations, the first user 110 walks around the environment 100 and views a live CGR environment on the screen that includes depictions of realistic occlusions between detected and tracked real objects having an accessible corresponding 3D models such as the sculpture 135 along with additional virtual content added to the CGR environment based on the techniques disclosed herein.

Examples of real objects in a physical environment that can be captured, depicted, and tracked include, but are not limited to, a picture, a painting, a sculpture, a light fixture, a building, a sign, a table, a floor, a wall, a desk, a book, a body of water, a mountain, a field, a vehicle, a counter, a human face, a human hand, human hair, another human body part, an entire human body, an animal or other living organism, clothing, a sheet of paper, a magazine, a book, a vehicle, a machine or other man-made object, and any other item or group of items that can be identified and modeled.

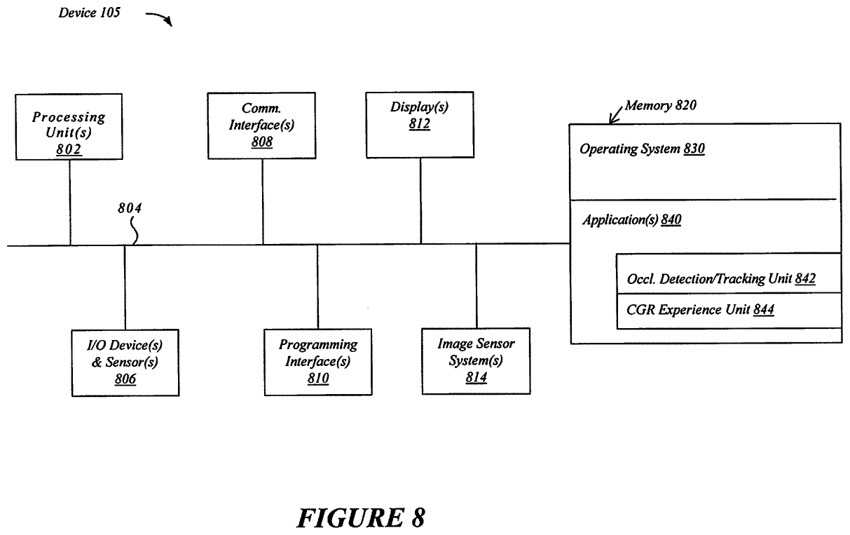

FIG. 8 is a block diagram illustrating device components of first device 105 according to some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the first device 105 includes one or more processing units 802 (e.g., microprocessors, ASICs, FPGAs, GPUs, CPUs, processing cores, or the like), one or more input/output (I/O) devices and sensors 806, one or more communication interfaces 808 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, or the like type interface), one or more programming (e.g., I/O) interfaces 810, one or more displays 812, one or more interior or exterior facing image sensor systems 814, a memory 820, and one or more communication buses 804 for interconnecting these and various other components.

In some implementations, the one or more communication buses 804 include circuitry that interconnects and controls communications between system components. In some implementations, the one or more I/O devices and sensors 806 include at least one of a touch screen, a soft key, a keyboard, a virtual keyboard, a button, a knob, a joystick, a switch, a dial, an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), or the like. In some implementations, movement, rotation, or position of the first device 105 detected by the one or more I/O devices and sensors 806 provides input to the first device 105.

In some implementations, the one or more displays 812 are configured to present a CGR experience. In some implementations, the one or more displays 812 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), or the like display types. In some implementations, the one or more displays 812 correspond to diffractive, reflective, polarized, holographic, etc. waveguide displays. In one example, the first device 105 includes a single display. In another example, the first device 105 includes a display for each eye. In some implementations, the one or more displays 812 are capable of presenting CGR content.

In some implementations, the one or more image sensor systems 814 are configured to obtain image data that corresponds to at least a portion of a scene local to the first device 105. The one or more image sensor systems 814 can include one or more RGB cameras (e.g., with a complimentary metal-oxide-semiconductor (CMOS) image sensor or a charge-coupled device (CCD) image sensor), monochrome camera, IR camera, event-based camera, or the like. In various implementations, the one or more image sensor systems 814 further include illumination sources that emit light, such as a flash.

The memory 820 includes high-speed random-access memory, such as DRAM, SRAM, DDR RAM, or other random-access solid-state memory devices. In some implementations, the memory 820 includes non-volatile memory, such as one or more magnetic disk storage devices, optical disk storage devices, flash memory devices, or other non-volatile solid-state storage devices. The memory 820 optionally includes one or more storage devices remotely located from the one or more processing units 802. The memory 820 comprises a non-transitory computer readable storage medium. In some implementations, the memory 820 or the non-transitory computer readable storage medium of the memory 820 stores the following programs, modules and data structures, or a subset thereof including an optional operating system 830 and one or more applications 840.

The operating system 830 includes procedures for handling various basic system services and for performing hardware dependent tasks. In some implementations, the operating system 830 includes built in CGR functionality, for example, including an CGR experience application or viewer that is configured to be called from the one or more applications 840 to display a CGR experience within a user interface.

The applications 840 include an occlusion detection/tracking unit 842 and a CGR experience unit 844. The occlusion detection/tracking unit 842 and CGR experience unit 844 can be combined into a single application or unit or separated into one or more additional applications or units. The occlusion detection/tracking unit 842 is configured with instructions executable by a processor to perform occlusion handling for a CGR experience using one or more of the techniques disclosed herein. The CGR experience unit 844 is configured with instructions executable by a processor to provide a CGR experience that includes depictions of a physical environment including real objects and virtual objects. The virtual objects may be positioned based on the detection, tracking, and representing of objects in 3D space relative to one another based on stored 3D models of the real objects and the virtual objects, for example, using one or more of the techniques disclosed herein.

In some implementations, block diagram illustrating components of first device 105 can similarly represent the components of an HMD, such as second device 115. Such an HMD can include a housing (or enclosure) that houses various components of the head-mounted device. The housing can include (or be coupled to) an eye pad disposed at a proximal (to the user) end of the housing. In some implementations, the eye pad is a plastic or rubber piece that comfortably and snugly keeps the HMD in the proper position on the face of the user (e.g., surrounding the eye of the user). The housing can house a display that displays an image, emitting light towards one or both of the eyes of a user.

FIG. 8 is intended more as a functional description of the various features which are present in a particular implementation as opposed to a structural schematic of the implementations described herein. As recognized by those of ordinary skill in the art, items shown separately could be combined and some items could be separated. For example, some functional modules shown separately in FIG. 8 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, or firmware chosen for a particular implementation.

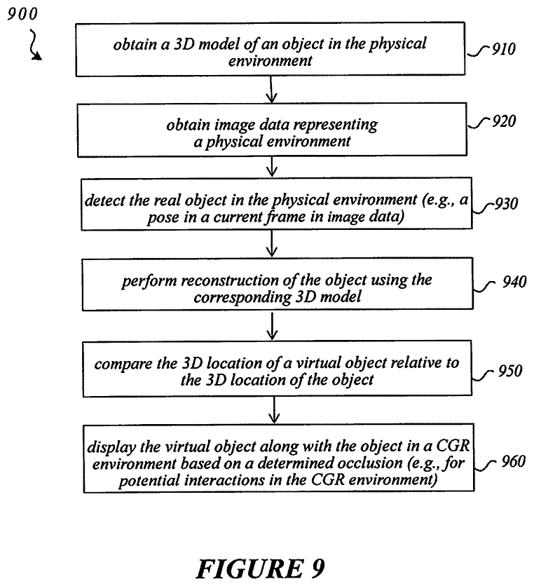

FIG. 9 is a flowchart representation of a method 900 for occlusion rendering in a CGR environment for a real object. In some implementations, the method 900 is performed by a device (e.g., first device 105 of FIGS. 1-8). The method 900 can be performed at a mobile device, HMD, desktop, laptop, or server device. The method 900 can be performed on a head-mounted device that has a screen for displaying 2D images or screens for viewing stereoscopic images. In some implementations, the method 900 is performed by processing logic, including hardware, firmware, software, or a combination thereof. In some implementations, the method 900 is performed by a processor executing code stored in a non-transitory computer-readable medium (e.g., a memory).

At block 910, the method 900 obtains a 3D virtual model of a real object (e.g., sculpture 135). In various implementations, the 3D model of the real object represents the 3D surface or 3D volume of the real object (e.g., sculpture 135). In some implementations, the user finds or accesses the 3D model of the sculpture 135 from a searchable local or remote site. For example, at a museum there may be accessible 3D models for one, some or all pieces of art in the museum.

At block 920, the method 900 obtains image data representing a physical environment. Such image data can be acquired using an image sensor such as camera. In some implementations, the image data includes a sequence of frames acquired one after another or in groups of images. An image frame can include image data such as pixel data identifying the color, intensity, or other visual attributes captured by an image sensor at one time.

At block 930, the method 900 detects a real object from the physical environment in a current frame in the image data. In various implementations, the method 900 determines a pose of the real object in the current frame of the image data. In some implementations, the method 900 can detect a real object and determine its pose (e.g., position and orientation in 3D space) based on known 2D or 3D object detection and localization algorithms, VIO information, infrared data, depth detection data, RGB-D data, other information, or some combination thereof. In one example, the real object is detected in each image frame. In one implementation, after pose detection in a first frame, in subsequent frames of the sequence of frames, the method 900 can determine an appropriate transform (e.g., adjustment of the pose) to determine the pose of the object in each subsequent frame. This process of determining a new transpose and associated new pose with each current frame continues, providing ongoing information about the current pose in each current frame as new frames are received.

At block 940, the method 900 performs reconstruction of the real object using the corresponding 3D model. This can involve using the obtained 3D virtual model of the real object as a reconstruction of the real object in the depicted physical environment. In some implementations, VIO is used to determine a location of the real object in a 3D space used by a VIO system based on the location of the real object in the physical environment (e.g., 2 meters in front of the user). In some implementations, the VIO system analyzes image sensor or camera data (“visual”) to identify landmarks used to measure (“odometry”) how the image sensor is moving in space relative to the identified landmarks. Motion sensor (“inertial”) data is used to supplement or provide complementary information that the VIO system compares to image data to determine its movement in space. In some implementations, a depth map is created for the real object and used to determine the pose of the 3D model in a 3D space. In some implementations, the VIO system registers the 3D model with the pose of the real object in the a 3D space. In some implementations, the 3D model of the real object is rendered in a CGR environment using the determined pose of the real object in the current frame image.

At block 950, the method 900 compares the 3D location of a virtual object relative to the 3D location of the real object. In some implementations, the method 900 identifies the virtual object (e.g., the virtual object 510) to be included in the CGR environment (e.g., CGR environment 500), for example, based on the identity of the real object, user input, computer implemented instructions in an application, or any other identification technique. At block 950, the method 900 compares the locations of the virtual object and the real object in a 3D space to determine whether an occlusion should be displayed. In some implementations, poses and 3D geometry information of the real object and virtual object are compared. In some implementations, using its coordinate system, a VIO system tracks where the real object and the virtual object are in a 3D space used by the VIO system. In various implementations, a relative position is determined that includes a relative position between the virtual object and the 3D model of the real object, a relative position between the virtual object and the user (e.g., image sensor or camera pose), a relative position between the 3D model of the real object and the user, or combinations thereof

The comparison from block 950 can be used to realistically present an occlusion between the virtual object and the 3D model of the real object from the perspective of the user. In various implementations, the CGR environment accurately depicts when the virtual object is in front and occludes all or part of the 3D model of the real object. In various implementations, the CGR environment accurately depicts when the 3D model of the real object is in front and occludes all or part of the virtual object.

In various implementations, the comparison of the 3D location of a virtual object relative to the 3D location of the real object is further used to address object collisions, shadows, and other potential interactions between the virtual object and the real object in the CGR environment.

At block 960, the method 900 displays the virtual object with the real object in the CGR environment based on the determined occlusion. In some implementations, the method 900 presents the CGR environment including a physical environment and additional content. In some implementations, the method 900 presents the CGR environment depicting the physical environment and the additional content. In various implementations, at block 960, the virtual object is displayed along with the real object in a CGR environment depicting the physical environment.

The CGR environment can be experienced by a user using a mobile device, head-mounted device (HMD), or other device that presents the visual or audio features of the environment. The experience can be, but need not be, immersive, e.g., providing most or all of the visual or audio content experienced by the user. A CGR environment can be video-see-through (e.g., in which the physical environment is captured by a camera and displayed on a display with additional content) or optical-see-through (e.g., in which the physical environment content is viewed directly or through glass and supplemented with displayed additional content). For example, a CGR environment system may provide a user with video see-through CGR environment on a display of a consumer cell-phone by integrating rendered three-dimensional (“3D”) graphics into a live video stream captured by an onboard camera. As another example, a CGR system may provide a user with optical see-through CGR environment by superimposing rendered 3D graphics into a wearable see-through head mounted display (“HMD”), electronically enhancing the user's optical view of the physical environment with the superimposed additional content.

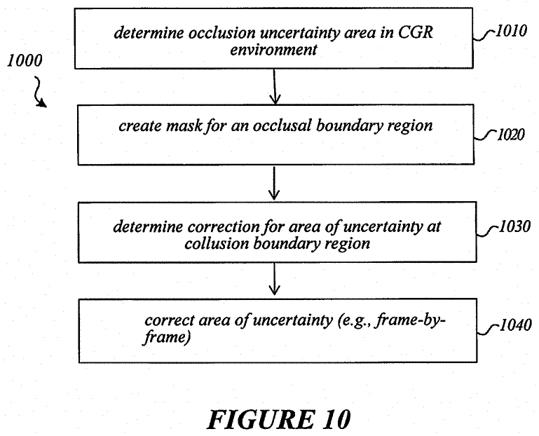

FIG. 10 is a flowchart representation of a method 1000 for occlusion boundary determination in a CGR environment for a real object and a virtual object according to some implementations. In some implementations, the method 1000 is performed by a device (e.g., first device 105 of FIGS. 1-8). The method 1000 can be performed at a mobile device, HMD, desktop, laptop, or server device. The method 1000 can be performed on a head-mounted device that has a screen for displaying 2D images or screens for viewing stereoscopic images. In some implementations, the method 1000 is performed by processing logic, including hardware, firmware, software, or a combination thereof. In some implementations, the method 1000 is performed by a processor executing code stored in a non-transitory computer-readable medium (e.g., a memory).

At block 1010, the method 1000 determines an occlusion uncertainty area in a CGR environment. In some implementations, the occlusion uncertainty area is based on an occlusion boundary. The occlusion uncertainty area can be a preset or variable number of pixels (e.g., 20 pixels wide or high at full image resolution). In some implementations, the occlusion uncertainty area can be based on the size of the virtual object or 3D model of the real object. Other estimations of the occlusion uncertainty area can be used.

At block 1020, the method 1000 creates a mask to resolve an occlusion boundary region between the virtual object or 3D model of the real object at the occlusion uncertainty area. In some implementations, a tri-mask can identify a first area that is determined to be outside the occlusion (e.g., not occluded), a second area that is determined to be inside the occlusion (e.g., occluded) and a third area of uncertainty in between the first area and the second area (e.g., pixels 764). In some implementations, although a very good approximation of the environment is determined, for example, by a VIO system, the third area of uncertainty can be caused in part by a mismatch between a determined 3D location of the virtual object relative to an image or sequence of images, captured for example, by an image sensor.

At block 1030, the method 1000 determines a correction for the third area of uncertainty. In some implementations, local consistency criteria including, but not limited to a color consistency, chromatic consistency, or depicted environment consistency is used with the first area and the second area to resolve the third area of uncertainty (e.g., eliminate the third area of uncertainty). In some implementations, one or more algorithms determine corrections for each pixel in the third area of uncertainty based on selected criteria. In some implementations, the correction can be implemented by re-assigning pixels in the third area of uncertainty to the first area or the second area, in whole or in part, based on the selected criteria.

At block 1040, the method 1000 corrects the third area of uncertainty before generating or displaying the CGR environment. In some implementations, the method 1000 applies the correction to the depiction of the CGR environment. In various implementations, the correction can be implemented frame-by-frame. In some implementations, the correction can be assisted by information from one or more previous frames.

The techniques disclosed herein provide advantages in a variety of circumstances and implementations. In one implementation, an app on a mobile device (mobile phone, HMD, etc.) is configured to store or access information about objects, e.g., paintings, sculptures, poster etc., in a particular venue, such as a movie theater or museum. This information can include a 3D model corresponding to the real object that can be used improve occlusions between the real object and a virtual object that when such object's block one another in a CGR environment. Using a 3D model of the real object improves the accuracy and the efficiency of determining the occlusion determinations. In some circumstances, the use of the 3D model of the real object enables occlusion determinations to occur in real-time, e.g., providing occlusion-enabled CGR environments that correspond to images captured by a device at or around the time each of the images is captures.

Numerous specific details are set forth herein to provide a thorough understanding of the claimed subject matter. However, those skilled in the art will understand that the claimed subject matter may be practiced without these specific details. In other instances, methods apparatuses, or systems that would be by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” or “comprising,” when used in this specification, specify the presence of stated features, integers, steps, operations, elements, or components, but do not preclude the presence or addition of one or more other features, integers, steps, operations, elements, components, or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the disclosure are to be understood as being in every respect illustrative and exemplary, but not restrictive, and the scope of the disclosure disclosed herein is not to be determined only from the detailed description of illustrative implementations but according to the full breadth permitted by patent laws. It is to be understood that the implementations shown and described herein are only illustrative of the principles of the present disclosure and that various modification may be implemented by those skilled in the art without departing from the scope and spirit of the disclosure.

What is claimed is:

1. A method comprising:
on a computing device having a processor, a memory, and an image sensor:
obtaining an image of a physical environment using the image sensor;
detecting a depiction of a real object in the image;
determining a 3D location of the object in a three dimensional (3D) space based on the depiction of the object in the image and a 3D model of the object;
determining an occlusion based on the 3D location of the real object and a 3D location of the virtual object in the 3D space; and
displaying a computer-generated reality (CGR) experience on a display based on the occlusion, the CGR experience comprising the real object and the virtual object, wherein at least a portion of the real object or the virtual object is occluded.

2. The method of claim 1, wherein the virtual object occludes the real object based on the occlusion, wherein the 3D location of the virtual object is closer to an image sensor location than the 3D location of the real object in the 3D space.

3. The method of claim 1, wherein the real object occludes the virtual object based on the occlusion, wherein the 3D location of the real object is closer to an image sensor location than the 3D location of the virtual object in the 3D space.

4. The method of claim 1, wherein determining the 3D location of the object in a 3D space is further based on visual inertial odometry.

5. The method of claim 1, where the determining an occlusion further comprises correcting an occlusion boundary region.

6. The method of claim 5, where the occlusion boundary region is caused by at least a mismatch between the 3D location of the object in the 3D space and the image of the physical environment from the image sensor.

7. The method of claim 6, further comprising correcting the occlusion boundary region by fixing a boundary region uncertainty based on a tri-mask and CGR experience color consistency.

8. The method of claim 5, further comprising correcting the occlusion boundary region frame by frame based on a single frame of the CGR experience.

9. The method of claim 5, further comprising correcting the occlusion boundary region based on one or more previous frames of the CGR experience.

10. The method of claim 1, further comprising adjusting locations of the 3D location of the real object or the 3D location of the virtual object in the 3D space based on one or more previous frames.

11. The method of claim 1, where the virtual object is an virtual scene surrounding the real object.

12. The method of claim 1, wherein the occluded spatial relationship comprises the virtual object partly occluded by the 3D model, the virtual object completely occluded by the 3D model, the 3D model partly occluded by the virtual object, or the 3D model completely occluded by the virtual object.

13. The method of claim 1, further comprising detecting a presence of the object and an initial pose of the object in an initial frame of the frames using a sparse feature-comparison technique.

14. A system comprising:
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
obtaining an image of a physical environment using the image sensor;
detecting a depiction of a real object in the image;
determining a 3D location of the object in a three dimensional (3D) space based on the depiction of the object in the image and a 3D model of the object;
determining an occlusion based on the 3D location of the real object and a 3D location of the virtual object in the 3D space; and
displaying a CGR experience on a display based on the occlusion, the CGR experience comprising the real object and the virtual object, wherein at least a portion of the real object or the virtual object is occluded.

15. The system of claim 14, where the determining an occlusion further comprises correcting an occlusion boundary region, where the occlusion boundary region is caused by at least a mismatch between the 3D location of the object in the 3D space and the image of the physical environment from the image sensor.

16. The system of claim 14, wherein the occluded spatial relationship comprises the virtual object partly occluded by the 3D model, the virtual object completely occluded by the 3D model, the 3D model partly occluded by the virtual object, or the 3D model completely occluded by the virtual object.

17. A non-transitory computer-readable storage medium, storing program instructions computer-executable on a computer to perform operations comprising:
obtaining an image of a physical environment using the image sensor;
detecting a depiction of a real object in the image;
determining a 3D location of the object in a three dimensional (3D) space based on the depiction of the object in the image and a 3D model of the object;
determining an occlusion based on the 3D location of the real object and a 3D location of the virtual object in the 3D space; and
displaying a CGR experience on a display based on the occlusion, the CGR experience comprising the real object and the virtual object, wherein at least a portion of the real object or the virtual object is occluded.

18. The non-transitory computer-readable storage medium of claim 17, where the determining an occlusion further comprises correcting an occlusion boundary region, wherein the occlusion boundary region is caused by at least a mismatch between the 3D location of the object in the 3D space and the image of the physical environment from the image sensor.

19. The non-transitory computer-readable storage medium of claim 17, wherein the occluded spatial relationship comprises the virtual object partly occluded by the 3D model, the virtual object completely occluded by the 3D model, the 3D model partly occluded by the virtual object, or the 3D model completely occluded by the virtual object.
